(19) United States
(12) Patent Application Publication
(10) Pub. No.: US 2018/0292820 A1
(43) Pub. Date: Oct. 11, 2018

(54) SYSTEM LIMITS OF AN AUTOMATIC CONTROL

(71) Applicant: Robert Bosch GmbH, Stuttgart (DE)

(72) Inventor: Claus Marberger, Weil Der Stadt (DE)

(21) Appl. No.: 15/570,949

(22) PCT Filed: May 10, 2016
(86) PCT No.: PCT/EP2016/060423

§ 371 Date: Oct. 31, 2017

(30) Foreign Application Priority Data
May 22, 2015 (DE) 10 2015 209 476.6

(51) Int. Cl. G05D 1/00; B60W 50/14

(52) U.S. Cl. CPC G05D 1/0061; B60W 2050/0072; G05D 2201/0213; B60W 50/14

(57) ABSTRACT

A method for transferring control from an automatic control to an operator includes the steps of detecting a first time period in which the automatic control may probably be maintained, of determining a second time period which the operator needs to take over control, and of outputting a message to the operator if the first time period is longer than the second time period by less than a predetermined interval. For this purpose, the second time period is determined as a function of a situation of the operator.

### FIELD

The present invention relates to an automatic control, in particular on board a motor vehicle.

### BACKGROUND INFORMATION

A motor vehicle includes an automatic control for controlling at least one aspect of the movement of the motor vehicle independently of a driver. The control may include a longitudinal or transversal control of the motor vehicle, for example. In order to carry out the control, the surroundings of the motor vehicle are usually scanned and the control is carried out as a function of the scanning result. In general, each automatic control is subject to predetermined system limits beyond which a control is no longer possible. In this case, the control must be transferred to the driver of the motor vehicle. The amount of time available to the driver to take over control is crucial in this case. If there is only little time available, it is possible that the driver is overwhelmed with taking over control over the motor vehicle, which may result in a dangerous driving situation. If, however, a sufficient amount of time is available, the automatic control must be capable of extensively anticipating the controllability of the motor vehicle. An evaluation of the controllability of the motor vehicle further 1n the future is, however, subject to considerable uncertainty so that driver-independent control over the motor vehicle may overall be offered less frequently.

An object of the present invention is to provide an improved technology for transferring the control from an automatic control to an operator. The present invention achieves this object with the aid of a method, a computer program product, and a device. Preferred specific embodiments are described herein.

### SUMMARY

A method for transferring control from an automatic control to an operator includes the steps of detecting a first time period in which the automatic control may probably be maintained, of determining a second time period which the operator needs to take over control, and of outputting a message to the operator if the first time period is longer than the second time period by less than a predetermined interval. For this purpose, the second time period is determined as a function of a situation of the operator.

The second time period may be determined more precisely by taking into account the situation of the operator. For example, taking over the guidance of a motor vehicle in a first situation, in which the driver is asleep, may require a longer second time period than in a second situation, in which the driver is awake. The message prompts the operator to get ready to take over control or to take over control over the vehicle guidance. This message may be output in an improved manner when the time instantaneously needed for the operator to take over approaches the duration of the first time period. If the predetermined interval, which lies between the first and the second time period, is selected to be very short, the takeover, if necessary, may take place at the last possible moment. If, however, the interval is selected to be long, the driver may be provided a prolonged takeover period. However, more frequent messages with regard to increasing the readiness to take over are also to be expected in this case.

Preferably, the second time period is determined as a function of an instantaneous activity of the operator. The activity may, for example, be classified into different states of excitation of the operator, for example asleep, resting, working or deep in conversation. Every activity may be assigned a corresponding second time period. The second time period may moreover be a function of a situation of the controlled object. A driving situation may in particular have an effect on the length of the second time period in the example of the controlled motor vehicle. If, for example, the motor vehicle is driving at a low velocity and good visibility on a clear road, the second time period may be relatively long, while in the case of poor visibility and higher velocity or a confusing traffic situation, the second time period may be shorter.

The second time period may also be determined as a function of an activity which the operator must carry out to take over control. The activity may be a function of the type of automatic control. The planned activity may be characterized in different actions, for example, which are involved in control of the controlled system; in the above-named example of the motor vehicle these may include steering, braking, or analyzing the driving situation, for example. Steering or braking by themselves may require a short takeover time, while analyzing the traffic situation, potentially in addition to steering and/or braking, may take considerably longer.

The second time period may in particular be determined on the basis of a transition period from the instantaneous to the planned activity. Transition periods, on the basis of which the second time period may be determined, may be tabularly predefined with regard to the categories created in each case. In another specific embodiment, an algorithm, a characteristic map, a function, or another connection between the second time period and the two activities may be predefined.

The activity of the operator may include a sensory, a motor, or a cognitive aspect. For example, a physical posture or activation of the operator may be detected in order to assess his/her motor activity. By differentiating the activity of the operator into different aspects, it is possible to determine the second time period at a smaller granularity. This makes it possible to obtain a more accurate result.

In one particularly preferred specific embodiment, the activity includes multiple aspects, the second time period being determined on the basis of a model which establishes which aspects may be changed consecutively and which may be changed in parallel to one another. Various physiological connections may thus be taken into account when activating the operator. The second time period for activating the operator may thus be determined in a more improved manner.

In one specific embodiment, the predetermined interval is modifiable by the operator. A preference of the operator to be preferably warned less often and with higher urgency or rather more often and with reduced urgency may thus be taken into account.

Following the message, the operator should adapt his/her behavior in such a way that the control over the vehicle guidance may be taken over rapidly. It is furthermore preferred that a separate takeover instruction is output to the operator if the first time period is shorter or equal to the second time period. In this case, the control takeover should take place immediately and preferably in an expedited manner. Safety of the controlled object may thus be enhanced.

A computer program product includes program code means for carrying out the described method, when the computer program product runs on a processing unit or is stored on a computer-readable data carrier.

A device for transferring control from an automatic control to an operator includes an interface for detecting a first time period in which the automatic control may probably be maintained, a scanning device for determining a situation of the operator, a processing device which is configured to determine a second time period which the operator needs to take over control, and to determine whether the first time period is longer than the second time period by less than a predetermined interval, and an outputting device for outputting a message to the operator.

### BRIEF DESCRIPTION OF THE DRAWINGS

The present invention is described in greater detail below with reference to the figures.

FIG. 1 shows a motor vehicle including an automatic control.

FIG. 2 shows a prediction model.

FIG. 3 shows an illustration of a control transfer from an automatic control to an operator in the motor vehicle from FIG. 1.

FIG. 4 shows an illustration of chronological sequences on board the motor vehicle from FIG. 1.

### DETAILED DESCRIPTION OF EXAMPLE EMBODIMENTS

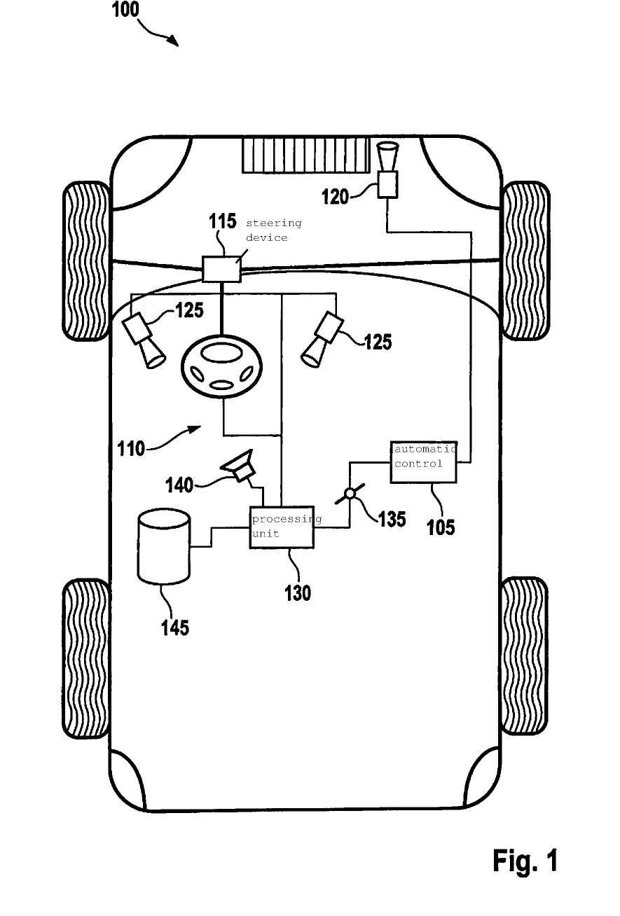

FIG. 1 shows a motor vehicle 100 including an automatic control 105. Automatic control 105 is configured to control an aspect of motor vehicle 100 independently of the driver. In particular, control 105 may involve a longitudinal or transversal control of motor vehicle 100. Control 105 may also implement an assisting function for an operator 110 (not illustrated), in particular in the form of a so-called driver assistant. The driver assistant may, for example, maintain a distance to a preceding motor vehicle, output an appropriate warning when a motor vehicle leaves a driving lane, or assist operator 110 in a different manner.

In one exemplary specific embodiment, automatic control 105 includes a lane keeping assistant. For this purpose, automatic control 105 is connected to a steering device 115 and a first sensor 120 for scanning an area ahead of motor vehicle 100. First sensor 120 may include a camera, for example. Control 105 determines the position of motor vehicle 100 with regard to the roadway boundaries on the basis of the data provided by sensor 120 and activates steering device 115 to keep motor vehicle 100 in the determined lane.

Automatic control 105 is subject to predetermined system limits. For example, a roadway ahead of motor vehicle 100 may be optically scanned only on a shortened area when motor vehicle 100 negotiates a curve, another motor vehicle cuts in ahead of motor vehicle 100, or the visual conditions compromise the evaluation of the camera information of first sensor 120.

Control 105 is therefore configured to determine a first time period over which it may probably maintain control over motor vehicle 100.

Operator 110 may usually take over control of motor vehicle 100 from automatic control 105 at any point in time. For this purpose, operator 110 may, for example, actuate an operating element of motor vehicle 100 or trigger a predetermined switch, for example. If automatic control 105 approaches its system limits so that it cannot maintain control over motor vehicle 100 much longer, operator 110 should be transferred in due time into a state in which he/she is ready to take over. In this case, a corresponding message or a warning—if necessary maintaining a predetermined safety period—should rot be output unnecessarily early in order to provide automatic control 105 with the opportunity to resolve the situation on its own accord.

A second time period, which operator 110 requires to take over control of motor vehicle 100, is usually a function of a situation of operator 110. It is proposed to determine the situation of operator 110 with the aid of a scanning device 125, for example, and to determine the second time period on the basis of the situation of operator 110. The situation of operator 110 may in particular depend on his/her activity. The activity may include different aspects which may be of sensory, motor, or cognitive nature. If, for example, the activity of operator 110 involves reading a book, for example, the motor aspect is usually weak, while the cognitive aspect is strong. A first sensory aspect of the visual perception is usually strong, while other sensory aspects of acoustic or haptic nature are usually weak. The activity of operator 110 may thus be assigned a sequence of different aspects of his/her activity. The individual aspects may be determined with the aid of dedicated scanning devices 125.

In order to determine the second time period which indicates how long operator 110 needs to stop his/her instantaneous activity and get ready for a planned activity within the scope of controlling motor vehicle 100, the planned activity may also be broken down into different aspects. The transition periods from different source aspects to different target aspects may be determined and the second time period may be determined on the basis of these transition periods. This determination may be carried out with the aid of a processing device 130. Processing device 130 is preferably connected to scanning device 125 for this purpose.

It is furthermore preferred that processing device 130 is connected to automatic control 105 with the aid of an interface 135. Processing device 130 may receive via interface 135 the first time period over which automatic control 105 may probably maintain control over motor vehicle 100. Processing device 130 compares the two time periods and, as a function of the comparison result, prompts operator 110 with the aid of an outputting device 140 to take over control. Processing device 130 is optionally connected to a memory 145 in which transfer periods in particular between an instantaneous and a planned activity of operator 110 may be stored. These data may be in particular updated based on measurements carried out by processing device 130. Furthermore, the data may refer to a specific operator 110.

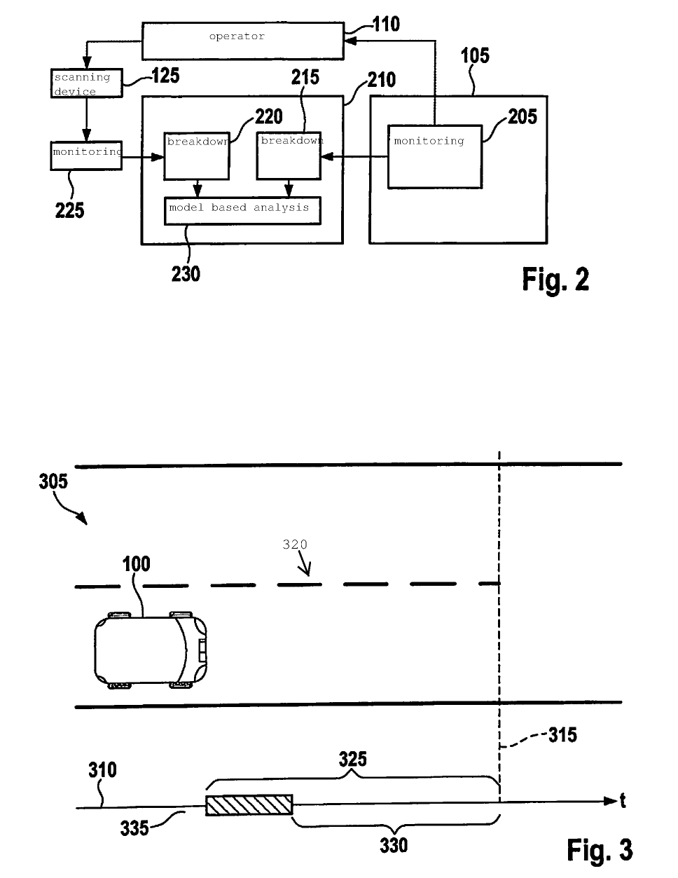

FIG. 2 shows a prediction model according to which control may be transferred from automatic control 105 to operator 110 on board motor vehicle 100 from FIG. 1. In this case, a logical sequence representation is involved according to which components may be assigned to individual devices on board motor vehicle 100.

Automatic control 105 includes a monitoring 205 of its system limits. Here, the first time period is in particular determined over which automatic control 105 may probably maintain control over motor vehicle 100.

Monitoring 205 provides information to an availability model 210 of operator 110 about the activities which the operator is supposed to carry out in order to take over control. The activity may be broken down into specific aspects, for example of sensory, motor, or cognitive nature, in a breakdown 215. In parallel thereto, a further breakdown 220 may take place which relates to an instantaneous activity of operator 110. The activity may be provided by further monitoring 225 which is based on the data of one or multiple scanning device(s) 125 of operator 110.

The activities or aspects of a present or a planned activity of operator 110, which were determined in breakdowns 215 and 220, are subjected to a model-based analysis 230. Here, it may be taken into account that some transitions may take place in parallel to one another, while others must be applied strictly sequentially. For example, a motor and a cognitive transition period may take place in parallel, so that the longer of the two transition periods is applied overall. A sensory, in particular a visual aspect, may, however, be contemplated separately from the motor and cognitive aspects so that its transition period must be added to the previously determined maximum. Other combinations are also possible. In one specific embodiment, the combination of different, transition periods is based on a processing model of operator 110.

The second time period, which is determined by model-based analysis 230, is provided to monitoring 205. Monitoring 205 subtracts the second time period from the first time period and determines whether the difference is greater than a predetermined interval. If this is not the case, a message to increase the degree of readiness to take over control over motor vehicle 100 may be output to operator 110. If the first time period is equally long or shorter than the second time period, an alarm signal may be additionally or alternatively output to operator 110 in order to prompt operator 110 to take over control immediately.

FIG. 3 shows an illustration of a control transfer from automatic control 105 to operator 110 in motor vehicle 100 from FIG. 1. In the upper area, motor vehicle 100 is illustrated on a roadway 305. It is assumed by way of example that motor vehicle 100 drives at a constant velocity from left to right in the illustration of FIG. 3. The positions of motor vehicle 100 are illustrated on a timeline 310 which is shown in the lower area of FIG. 3.

Automatic control 105 for controlling motor vehicle 100 includes by way of example a lane keeping system which is configured to keep the transverse position of motor vehicle 100 on roadway 305 on the basis of roadway marking 320. The lane keeping system may guarantee the transversal control as a function of the quality of the lane markings or other indications of the roadway boundary for a variable time period which may correspond to first time period. 325.

Operator 110 of motor vehicle 100 needs a second time period 330, which is preferably determined as a function of the situation of operator 110, to take over control from automatic control 105. In order to maintain control over motor vehicle 100 during the control transfer from automatic system [sic; control] 105 to operator 110 without interruptions, operator 110 must be ready to take over control no later than at the point in time when the estimated takeover period corresponds to the time period of the technical projection. It is preferred, however, that a message to increase the degree of readiness is already output to operator 110 when the first 115 time period is still longer than second time period 330 by a predetermined interval 335. Interval 335 may be, for example, settable or influenceable by operator 110.

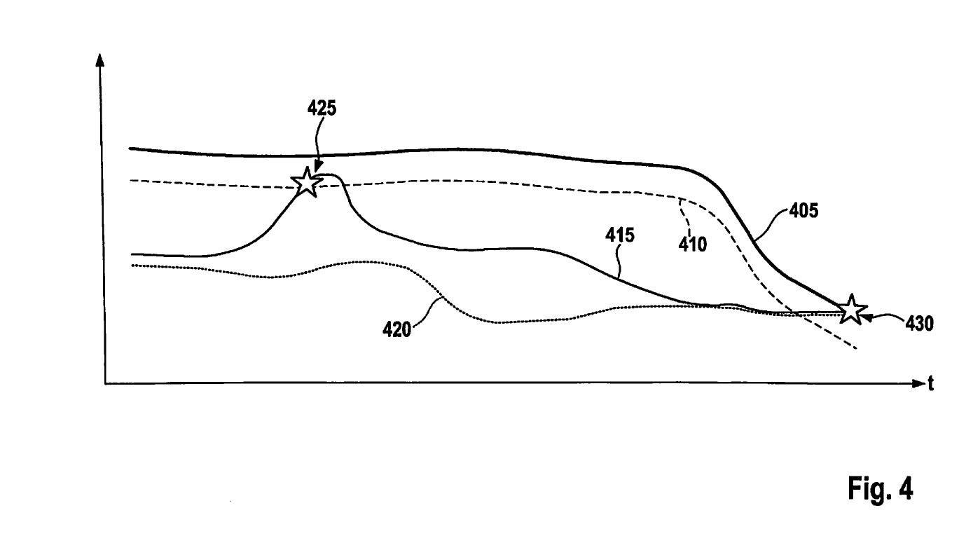

FIG. 4 shows an exemplary illustration of chronological sequences in a motor vehicle 100 such as the one in FIG. 1. A time is plotted in the horizontal direction and variables of time periods are plotted in the vertical direction. A first sequence 405 shows the duration of first time period 325, i.e., it thus indicates for how long it will probably still be possible to maintain automatic control 105. A second sequence 410 is selected to be shorter than first sequence 405 by a safety area.

A third sequence 415 represents second time period 330 which operator 110 needs to take over control from automatic control 105.

A fourth sequence 420 represents the minimum takeover period estimated according to the above discussions if the driver is in optimal state, if the driver is optimally prepared to take over control.

At a point in time 425, third sequence 415 exceeds second sequence 410: time period 330, which is necessary for the operator to take over control, is shorter than first time period 325, in which automatic control 105 may probably be maintained, by less than predetermined interval 335. A message is correspondingly output to operator 110 so that he/she may prepare for taking over control.

If third sequence 415 reaches or exceeds first sequence 405, as is the case at point in time 430, operator 110 must take over control immediately in order to prevent motor vehicle 100 from driving in an uncontrolled manner. A corresponding warning or takeover instruction is output to operator 110.

1-10. (canceled)

11. A method for transferring control from an automatic control to an operator, comprising:
detecting a first time period in which the automatic control can be maintained;
determining a second time period which the operator needs to take over control: and
outputting a message to the operator if the first time period is longer than the second time period by less than a predetermined interval;
wherein the second time period is determined as a function of a situation of the operator.

12. The method as recited in claim 11, wherein the second time period is determined as a function of a present activity of the operator.

13. The method as recited in claim 11, wherein the second time period is determined as a function of an activity which the operator is supposed to carry out to take over control.

14. The method as recited in claim 12, wherein the second time period is determined on the basis of a transition period from the present to a planned activity.

15. The method as recited in claim 13, wherein the activity of the operator includes one of a sensory, a motor, or a cognitive aspect.

16. The method as recited in claim 15, wherein the activity includes multiple aspects and the second time period is determined based on a model which establishes which aspects may be changed consecutively and which may be changed in parallel to one another.

17. The method as recited in claim 11, wherein the predetermined interval is modifiable by the operator.

18. The method as recited in claim 11, wherein a takeover instruction is output to the operator if the first time period is shorter or equal to the second time period.

19. A non-transitory computer-readable data carrier on which is stored a computer program including program code for transferring control from an automatic control to an operator, the computer program, when executed on a processing unit, causing the processing unit to perform:
detecting a first time period in which the automatic control can be maintained;
determining a second time period which the operator needs to take over control; and
outputting a message to the operator if the first time period is longer than the second time period by less than a predetermined interval;
wherein the second time period is determined as a function of a situation of the operator.

20. A device for transferring control from an automatic control o an operator, the device comprising:
an interface for detecting a first time period in which the automatic control can be maintained;
a scanning device for determining a situation of the operator;
a processing device which is configured to determine a second time period which the operator needs to take over control and to determine whether the first time period is longer than the second time period by less than a predetermined interval; and
an outputting device for outputting a call to action to the operator.
